(19) United States
(12) Patent Application Publication
(10) Pub. No.: US 2013/0294318 A1
(43) Pub. Date: Nov. 7, 2013

(54) EFFICIENT UPDATE OF TMGI LIST IN LTE EMBMS

(71) Applicant: QUALCOMM INCORPORATED, San Diego, CA (US)

(72) Inventors: Daniel AMERGA, San Diego, CA (US); Sivaramakrishna VEEREPALLI, San Diego, CA (US); Shailesh MAHESHWARI, San Diego, CA (US); Kuo-Chun LEE, San Diego, CA (US); Jack Shyh-Hurng SHAUH, San Diego, CA (US); Ankur VERMA, San Diego, CA (US); Zhen ZHANG, Beijing (CN); Muralidharan MURUGAN, San Diego, CA (US); Ralph Akram GHOLMIEH, San Diego, CA (US)

(73) Assignee: QUALCOMM INCORPORATED, San Diego, CA (US)

(21) Appl. No.: 13/831,509

(22) Filed: Mar. 14, 2013

Related U.S. Application Data
(60) Provisional application No. 61/642,436, filed on May 3, 2012.

(51) Int. Cl. H04W 4/06

(52) U.S. Cl. CPC H04W 4/06
USPC 370/312

(57) ABSTRACT

A method, an apparatus, and a computer program product for wireless communication are provided. The apparatus receives at least one MBMS service in at least one MBSFN area. The apparatus receives configuration information on at least one MCCH. The at least one MCCH includes an MCCH unassociated with the at least one MBSFN area. The MCCH unassociated with the at least one MBSFN area is an MCCH associated with an MBSFN area not currently being received by the apparatus. The apparatus constructs a list of TMGIs based on the configuration information. The apparatus updates the list of TMGIs based on at least one of an MCCH change notification message for each of the at least one MCCH or a user service description.

### CROSS-REFERENCE TO RELATED APPLICATION(S)

This application claims the benefit of U.S. Provisional Application Ser. No. 61/642,436, entitled “EFFICIENT UPDATE OF TMGI LIST IN LTE EMBMS” and filed on May 3, 2012, which is expressly incorporated by reference herein in its entirety.

### BACKGROUND

1. Field

The present disclosure relates generally to communication systems, and more particularly, to efficiently updating a temporary mobile group identity (TMGI) list in Long Term Evolution (LTE) evolved Multimedia Broadcast Multicast Service (eMBMS).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus receives configuration information on at least one MCCH. The apparatus constructs a list of TMGIs based on the configuration information. The apparatus updates the list of TMGIs based on at least one of an MCCH change notification message for each of the at least one MCCH or a user service description.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating a format of a Multicast Channel Scheduling Information Media Access Control control element.

FIG. 8 is a diagram for illustrating the reception of some eMBMS content.

FIG. 9 is a diagram used for illustrating an exemplary method.

FIG. 10 is a flow chart of a method of wireless communication.

FIG. 11 is a conceptual data flow diagram illustrating the data flow between different modules/means/components in an exemplary apparatus.

FIG. 12 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

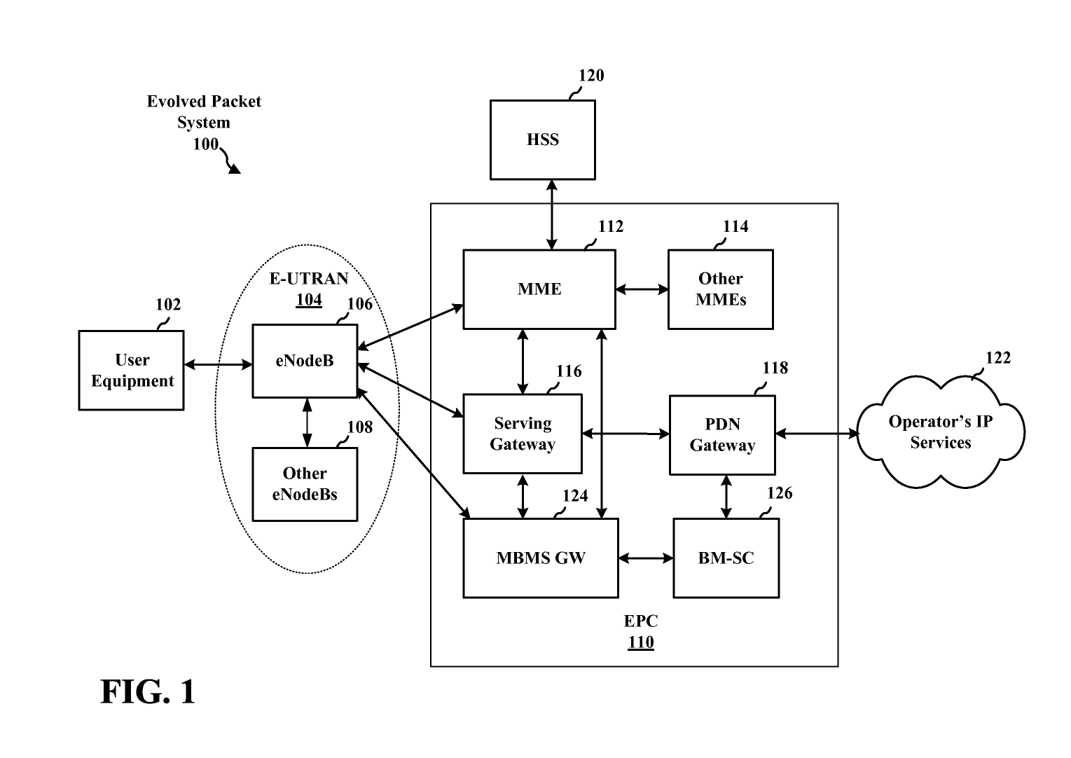

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 includes a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

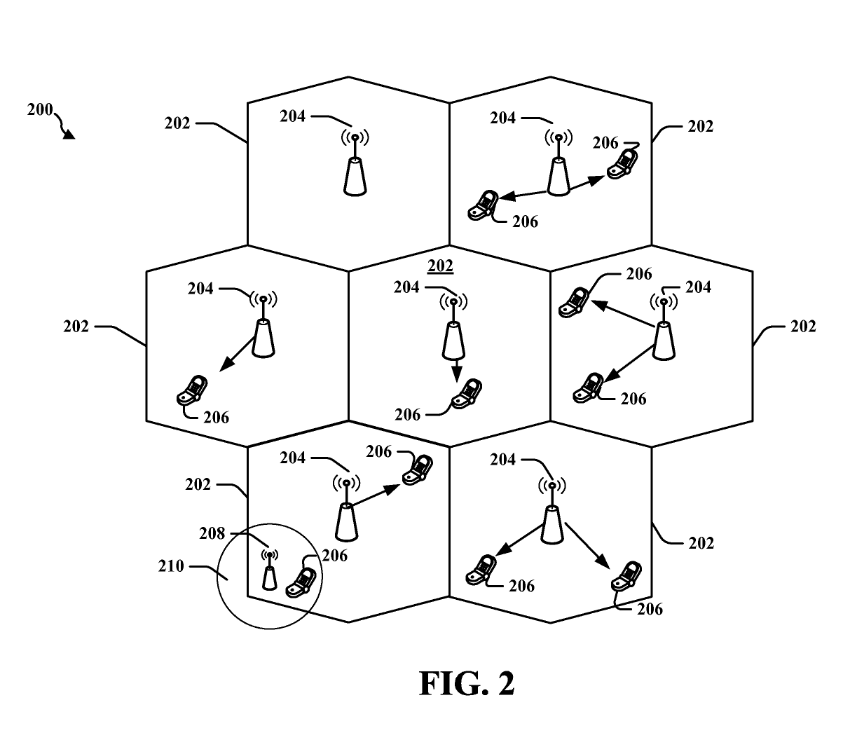

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

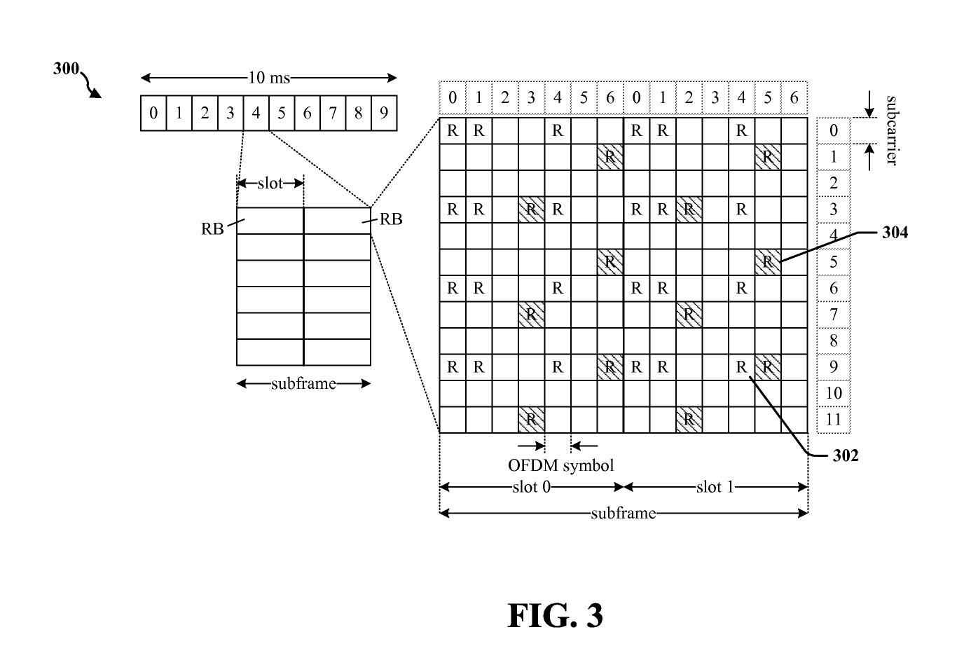

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

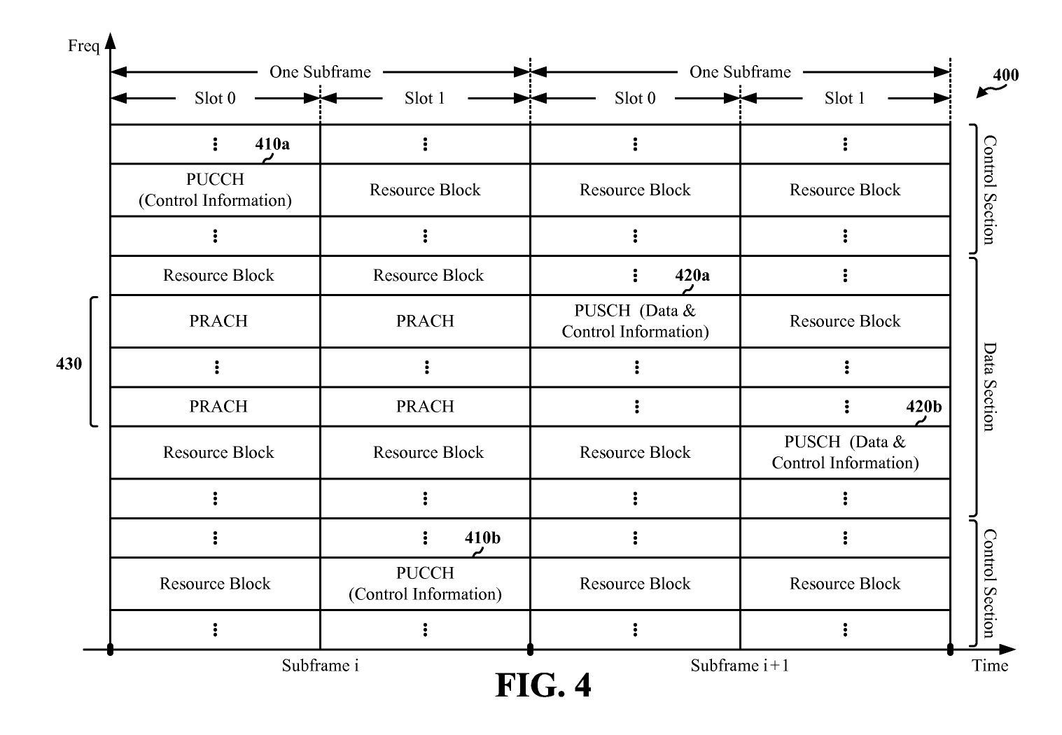

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

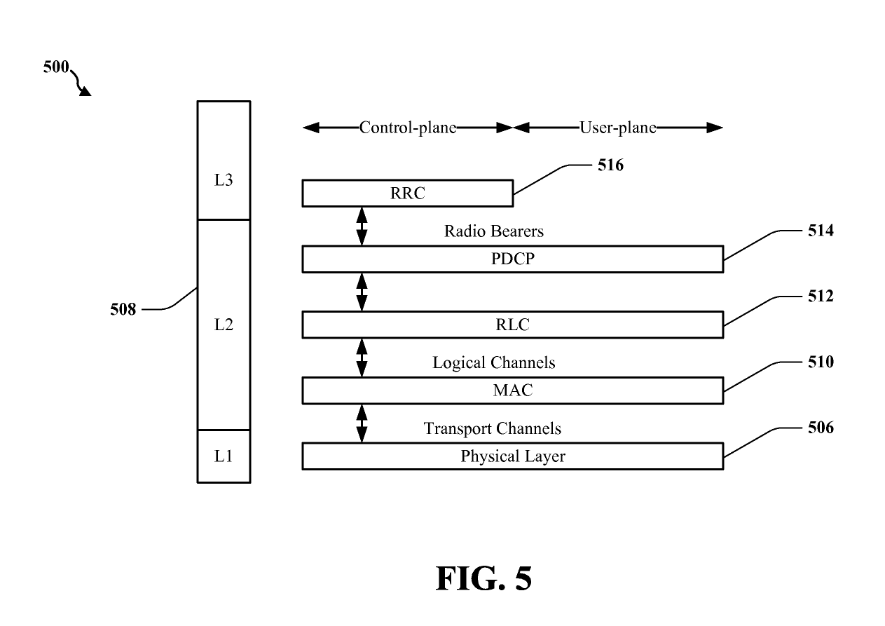

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

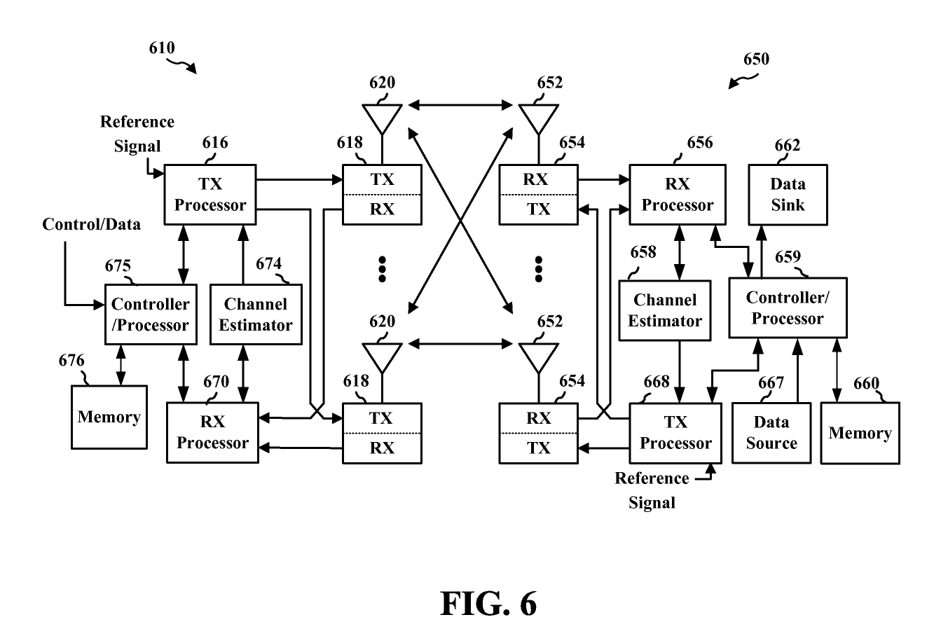

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

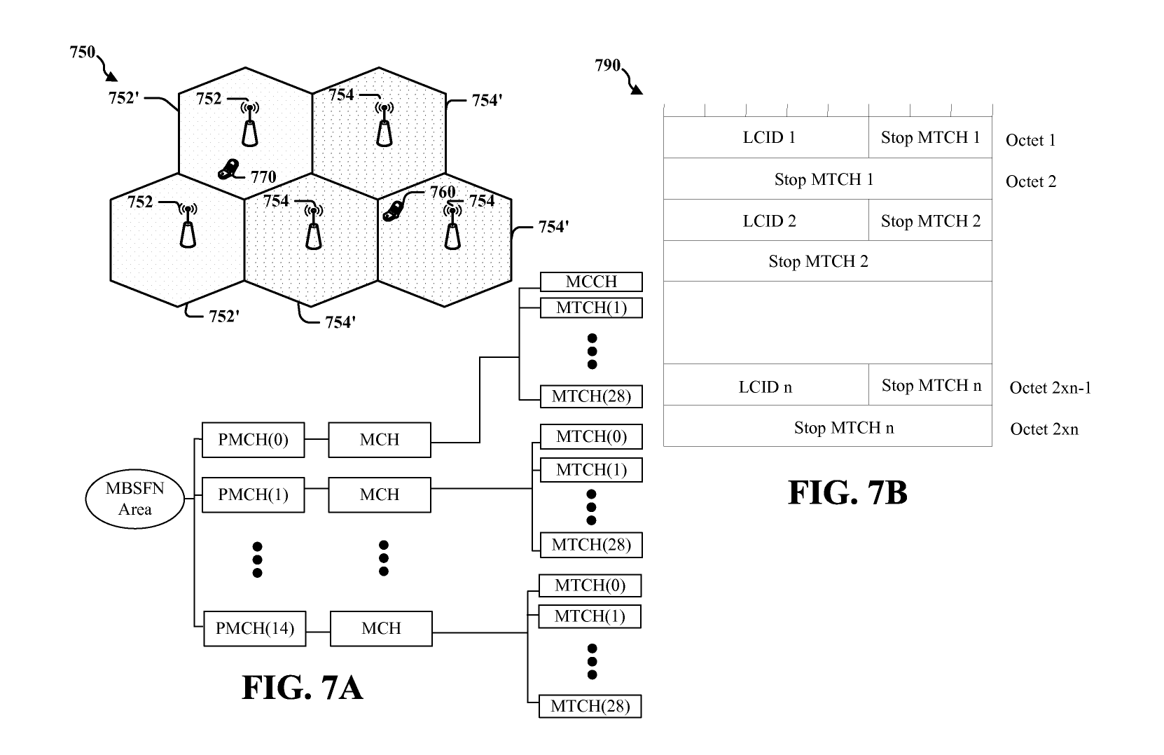

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE may acquire a system information block (SIB) 13 (SIB13). In a second step, based on the SIB13, the UE may acquire an MBSFN Area Configuration message on an MCCH. In a third step, based on the MBSFN Area Configuration message, the UE may acquire an MCH scheduling information (MSI) MAC control element. The SIB13 indicates (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message indicates (1) a temporary mobile group identity (TMGI) and an optional session identifier of each MTCH identified by a logical channel identifier within the PMCH, (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

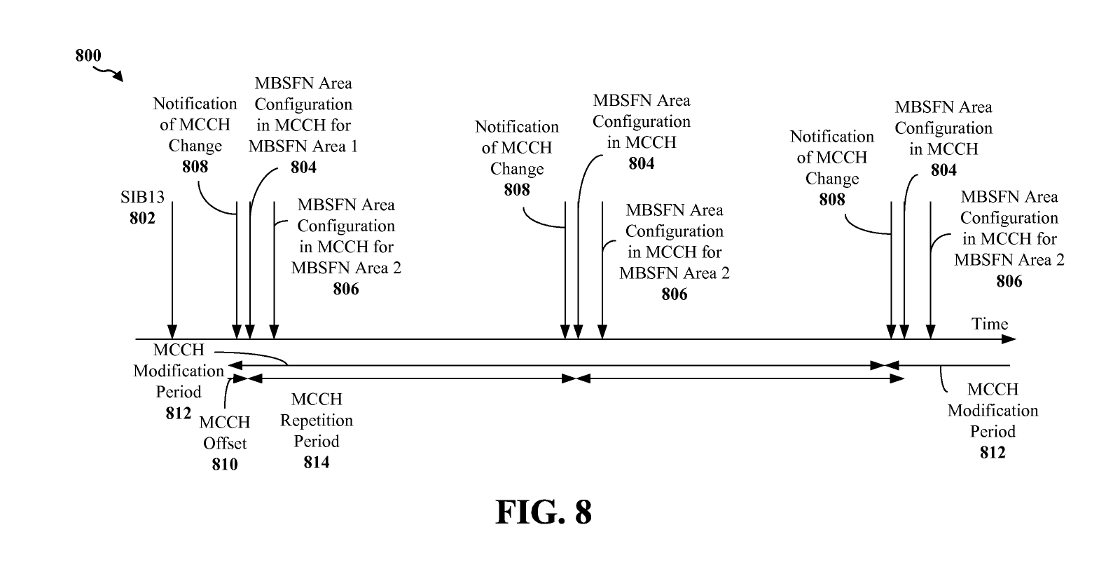

FIG. 8 is a diagram 800 for illustrating the reception of eMBMS content. A UE may receive a SIB13 802 from a serving eNB. As discussed supra, the SIB13 includes an MBSFN area identifier of each MBSFN area supported by the eNB. The SIB13 802 further includes information for acquiring an MCCH (e.g., the MCCH 804 and the MCCH 806) for each of the supported MBSFN areas, such as information regarding an MCCH repetition period 814, an MCCH offset 810, and an MCCH modification period 812. The MCCH repetition period 814 is the time period in which the MCCH carrying an MBSFN area configuration message repeats. The MCCH offset 810 is the offset of the start of the MCCH repetition period 814 from the MCCH modification period 812. The SIB13 802 further includes the signaling MCS, subframe allocation information, and MCCH change notification 808 configuration information. The serving eNB broadcasts a physical downlink control channel (PDCCH) downlink control information (DCI) 1C message encrypted by and addressed to an M radio network temporary identifier (M-RNTI) to notify of the MCCH change due to a new MBMS session added. The DCI 1C message may have an 8-bit bitmap, each bit indicating whether or not the MCCH has changed for the corresponding MBSFN area. The MCCH carries an MBSFN area configuration message. The MBSFN area configuration message includes a TMGI and an optional session ID of each MTCH associated with each PMCH of the MBSFN area, allocated resources for each PMCH of the MBSFN area, and an MSP within a common subframe allocation period over which MSI can be acquired.

A UE may receive a user service description (USD) (also may be referred to as a service announcement) on a service discovery channel. A USD describes information of an eMBMS service, such as a TMGI of the eMBMS service (which may or may not be available in the geographical area of the UE), a delivery method (e.g., download, streaming), and a protocol (e.g., file delivery over unidirectional transport (FLUTE)/user datagram protocol (UDP), real-time transport protocol (RTP) audio video profile (AVP) (referred to as RTP/AVP), etc.), a media type (e.g., audio, video, speech and timed media types, and other media types such as synthetic audio, still images, bitmap graphics, vector graphics, and text), and a start and end time of the eMBMS session. Once the UE has received the USD, the UE can camp on the LTE cell to discover the availability of eMBMS services.

There is a need for the UE to discover all available eMBMS services/TMGIs and report the eMBMS services/TMGIs to a user of the UE. A UE may discover all available TMGIs by acquiring MBSFN area configuration messages for each available MBSFN area each MCCH modification period 812. Acquiring MBSFN area configuration messages for each available MBSFN area each MCCH modification period 812 may be inefficient and may increase power consumption and CPU load. Methods are provided infra for a more efficient TMGI list updating procedure.

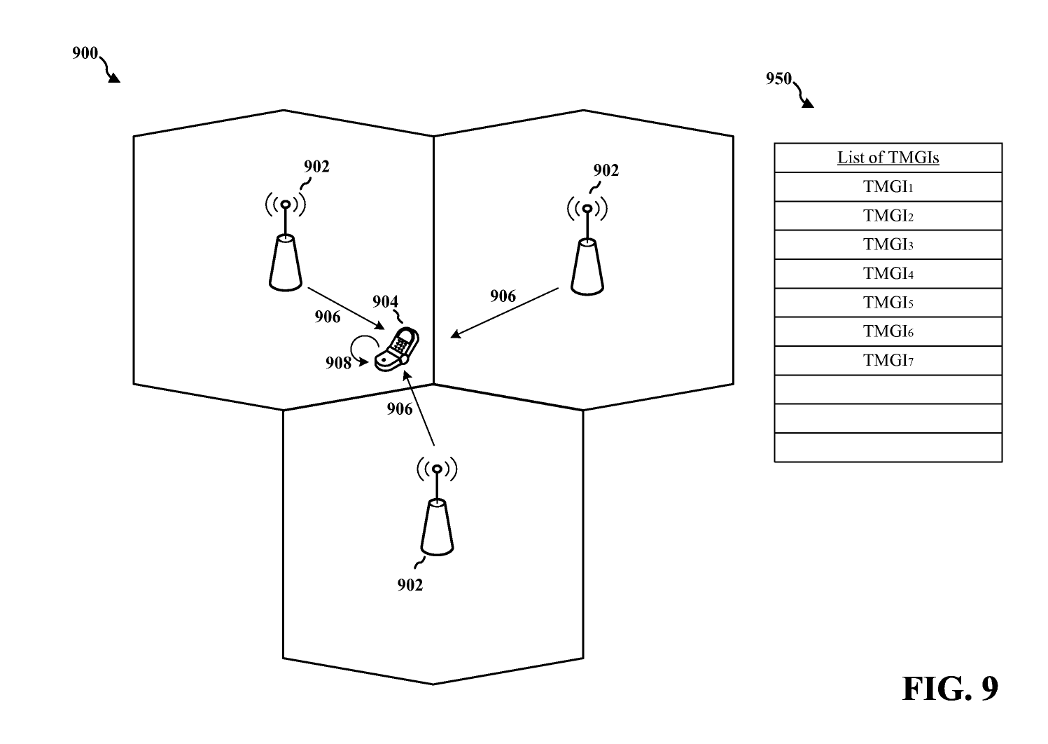

FIG. 9 is a diagram 900 used for illustrating an exemplary method. As shown in FIG. 9, the UE 904 is receiving at least one MBMS service in at least one MBSFN area provided by the eNBs 902. The eNBs 902 are transmitting MBMS content 906. The MBMS content may include the at least one MBMS service associated with the at least one MBSFN area; one or more MBSFN area configuration messages, one for each associated MBSFN area; MCCH change notifications for all associated MBSFN areas; and a USD. For example, assume the eNBs 902 are associated with and provide three MBSFN areas: MBSFN area 1, MBSFN area 2, and MBSFN area 3. Assume the UE 904 is receiving an MBMS service provided in MBSFN area 1. The eNBs 902 transmit MBMS content 906. The MBMS content 906 includes the MBMS service associated with the MBSFN area 1 (as well as other MBMS services not received by the UE 904), MBSFN area configuration messages for each of the MBSFN area 1, the MBSFN area 2, and the MBSFN area 3; MCCH change notifications for each of the MBSFN area 1, the MBSFN area 2, and the MBSFN area 3; and a USD.

The UE 904 receives configuration information on at least one MCCH. The configuration information may be MBSFN area configuration messages for each of the available MBSFN areas MBSFN area 1, MBSFN area 2, and MBSFN area 3. If the configuration information includes MBSFN area configuration messages for each of the available MBSFN areas MBSFN area 1, MBSFN area 2, and MBSFN area 3, the UE 904 receives a first MBSFN area configuration message for the MBSFN area 1, a second MBSFN area configuration message for the MBSFN area 2, and a third MBSFN area configuration message for the MBSFN area 3. The first MBSFN area configuration message is associated with the MBSFN area currently being received by the UE 904. The second and third MBSFN area configuration messages are unassociated with the MBSFN area currently being received by the UE 904. Accordingly, the at least one MCCH includes an MCCH unassociated with the at least one MBSFN area currently being received by the UE 904. That is, the UE 904 acquires at least one MCCH unassociated with the MBSFN area 1, and associated with an MBSFN area not currently being received, such as the MBSFN area 2 and/or the MBSFN area 3. The UE 904 constructs a list of TMGIs 950 based on the configuration information. The UE 904 updates 908 the list of TMGIs 950 based on an MCCH change notification message for each of the at least one MCCH and/or a USD. As discussed supra, each of the at least one MCCH is associated with a different MBSFN area. Accordingly, the UE 904 may update the list of TMGIs 950 based on MCCH change notification messages received for each of the MBSFN areas MBSFN area 1, MBSFN area 2, and MBSFN area 3 and/or based on a received USD. The exemplary methods are described in more detail infra.

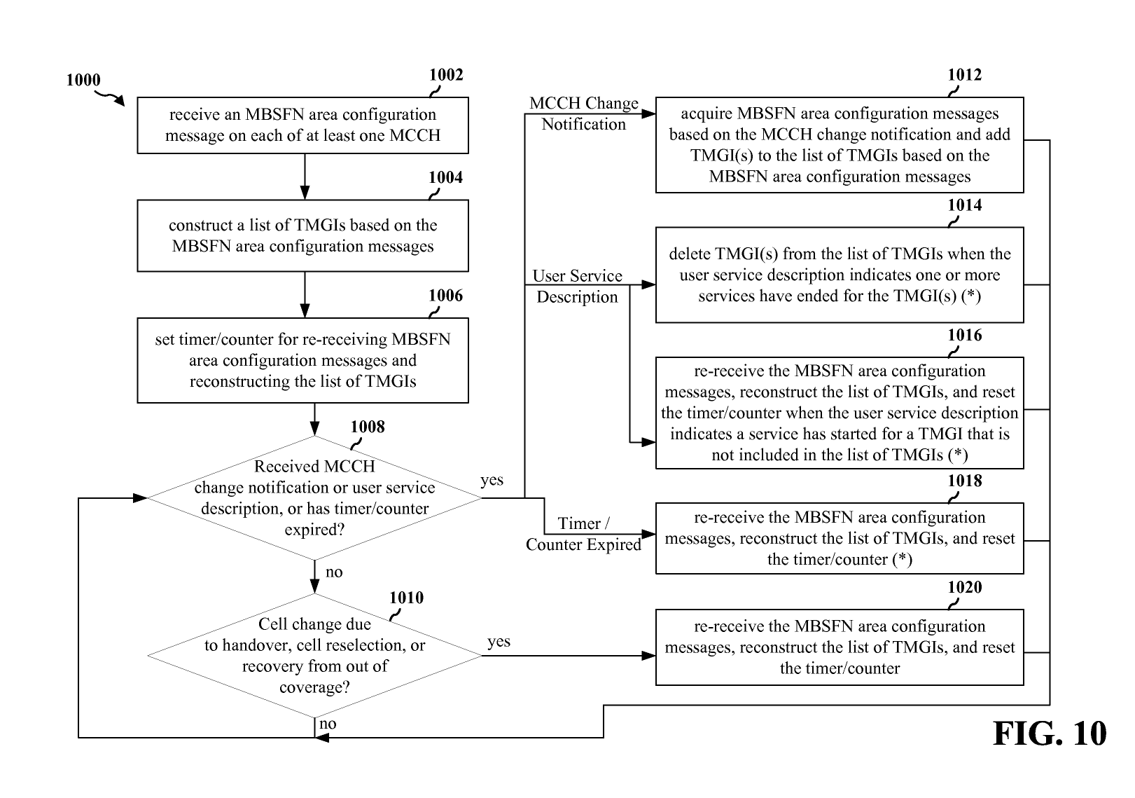

FIG. 10 is a flow chart 1000 of a method of wireless communication. The method may be performed by a UE. In step 1002, a UE receives an MBSFN area configuration message on each of at least one MCCH. In step 1004, the UE constructs a list of TMGIs based on the MBSFN area configuration messages. In step 1006, the UE sets a timer/counter for re-receiving MBSFN area configuration messages and reconstructing the list of TMGIs. In step 1008, the UE determines whether an MCCH change notification and/or a USD is received, or whether the timer/counter has expired. If in step 1008 an MCCH change notification has been received, in step 1012, the UE acquires MBSFN area configuration messages for the MBSFN areas indicated in the MCCH change notification. The MCCH change notification indicates for which MBSFN areas the MCCH has changed due to an addition of a session. The MCCH change notification does not indicate when the MCCH has changed due to a deletion of a session. The UE determines one or more TMGIs that are now included in the acquired MBSFN area configuration messages, and adds the one or more TMGIs to the list of TMGIs. If a TMGI in the list of TMGIs is no longer included in the acquired MBSFN area configuration messages, the UE also deletes that TMGI from the list of TMGIs. After step 1012, the UE returns to step 1008. If in step 1008 a USD has been received and the USD indicates that one or more services have ended, in step 1014, the UE deletes one or more TMGIs that correspond to the one or more services from the list of TMGIs. After step 1014, the UE returns to step 1008. If in step 1008 a USD has been received and the USD indicates that a service has started for a TMGI that is not included in the list of TMGIs, in step 1016, the UE re-receives the MBSFN area configuration messages, reconstructs the list of TMGIs, and resets the timer/counter. After step 1016, the UE returns to step 1008. If in step 1008 the timer/counter has expired, in step 1018, the UE re-receives the MBSFN area configuration messages, reconstructs the list of TMGIs, and resets the timer/counter. After step 1018, the UE returns to step 1008.

If in step 1008, the UE determines that an MCCH change notification has not been received, a USD has not been received, and the timer/counter has not expired, in step 1010, the UE determines whether there has been a cell change due to handover (while in an RRC_CONNECTED mode), a cell reselection (while in an RRC_IDLE mode), or a recovery from out of coverage. If there has not been a cell change due to handover, a cell reselection, or a recovery from out of coverage, the UE returns to step 1008. If in step 1010 there has been a cell change due to handover, a cell reselection, or a recovery from out of coverage, in step 1020, the UE re-receives the MBSFN area configuration messages, reconstructs the list of TMGIs, and resets the timer/counter. After step 1020, the UE returns to step 1008. In steps 1014, 1016, and 1018, if the UE is receiving an eMBMS service(s), the UE may not acquire the MBSFN area configuration message(s) for the MBSFN area(s) providing the eMBMS service(s). For example, if the UE may receive eMBMS services through MBSFN area 1, MBSFN area 2, and MBSFN area 3 and the UE is currently receiving an eMBMS service through MBSFN area 1, in steps 1014, 1016, and 1018 (with the asterisk (*)), the UE may only acquire the MBSFN area configuration messages for MBSFN area 2 and MBSFN area 3. When the UE is receiving an eMBMS service through MBSFN area 1, the UE may be continuously acquiring all of the MBSFN area configuration messages for MBSFN area 1, and therefore may not need to acquire the MBSFN area configuration messages for the MBSFN area 1 as part of steps 1014, 1016, and 1018.

In step 1002, the UE receives configuration information on at least one MCCH. The at least one MCCH includes an MCCH unassociated with the at least one MBSFN area. That is, the at least one MCCH includes an MCCH that is associated with an MBSFN area not currently being received by the UE. For example, if the UE is receiving an eMBMS service from the MBSFN area 1, but not from the MBSFN area 2 or the MBSFN area 3, the at least one MCCH includes an MCCH associated with the MBSFN area 2 and/or an MCCH associated with the MBSFN area 3. In step 1004, the UE constructs a list of TMGIs based on the configuration information. In steps 1012, the UE updates the list of TMGIs based on an MCCH change notification message for each of the at least one MCCH, and in step 1014, the UE updates the list of TMGIs based on a USD.

In one configuration, in step 1012, the UE updates the list of TMGIs by receiving an MCCH change notification for the at least one MCCH, determining that the MCCH change notification indicates a change for one or more MCCHs of the at least one MCCH, acquiring the configuration information for the one or more MCCHs, and adding at least one TMGI to the list of TMGIs based on the configuration information. The UE may also update the list of TMGIs by deleting at least one TMGI from the list based on the configuration information. For example, assume the UE is receiving an eMBMS service from MBSFN area 1, but not from MBSFN area 2 and MBSFN area 3. The UE may receive an MCCH change notification for a first MCCH of MBSFN area 2 and for a second MCCH of MBSFN area 3. The UE may determine that the MCCH change notifications indicate a change for both the first MCCH and the second MCCH. The UE may then acquire MBSFN configuration messages for the first and second MCCHs, and add at least one TMGI to the list of TMGIs or delete at least one TMGI from the list of TMGIs based on the acquired MBSFN area configuration messages.

In one configuration, in step 1014, the UE updates the list of TMGIs by receiving the USD, determining that a service has ended for a TMGI based on the USD, and deleting the TMGI from the list of TMGIs. In such a configuration, the one or more TMGIs may be unassociated with MBSFN areas currently being received by the UE. For example, assume the UE is receiving an eMBMS service from MBSFN area 1, but not from MBSFN area 2 and MBSFN area 3. The one or more TMGIs may be associated with the MBSFN area 2 and/or the MBSFN area 3 from which the UE is not currently receiving an eMBMS service.

In one configuration, in step 1020, the UE updates the list of TMGIs by re-receiving the configuration information and reconstructing the list of TMGIs for each of the at least one MCCH based on the configuration information upon a cell change due to a handover, cell reselection, or a recovery from out of coverage.

In one configuration, in step 1018, the UE updates the list of TMGIs by re-receiving the configuration information and reconstructing the list of TMGIs for one or more MCCHs of the at least one MCCH based on the configuration information periodically once every n MCCH modification periods, where n is greater than or equal to 350. If the MCCH modification period is 1024 radio frames, the value n=350 would result in the reconstruction of the list of TMGIs at least every hour. Generally, if the periodic reconstruction is to occur once every M hours, then n≈360000M/P, where P is the radio frame MCCH modification period (e.g., 512 or 1024 radio frames). In one configuration, M=8, and therefore the reconstruction of the list of TMGIs occurs at least every 8 hours. However, other configurations are possible. The one or more MCCHs may be unassociated with MBSFN areas currently being received by the UE. For example, assume the UE is receiving an eMBMS service from MBSFN area 1, but not from MBSFN area 2 and MBSFN area 3. The one or more MCCHs may be associated with the MBSFN area 2 and/or the MBSFN area 3 from which the UE is not currently receiving an eMBMS service.

In one configuration, in step 1016, the UE updates the list of TMGIs by receiving the USD, determining that a service has started for a TMGI based on the USD, determining that the TMGI is not in the list of TMGIs, and re-receiving the configuration information and reconstructing the list of TMGIs based on the configuration information for one or more MCCHs of the at least one MCCH. The one or more MCCHs may be unassociated with MBSFN areas currently being received by the UE. For example, assume the UE is receiving an eMBMS service from MBSFN area 1, but not from MBSFN area 2 and MBSFN area 3. The one or more MCCHs may be associated with the MBSFN area 2 and/or the MBSFN area 3 from which the UE is not currently receiving an eMBMS service.

In one configuration, in step 1002, the at least one MCCH includes an MCCH for each MBSFN area indicated in a received SIB. For example, a received SIB13 may indicate available MBSFN areas including MBSFN area 1, MBSFN area 2, and MBSFN area 3. To build the initial list of TMGIs, the UE may receive an MBSFN area configuration message on the MCCH of each of the MBSFN areas MBSFN area 1, MBSFN area 2, and MBSFN area 3. However, because the UE is receiving an eMBMS service from the MBSFN area 1, in step 1002, the UE may acquire MBSFN area configuration messages only from MBSFN areas not currently being received. For example, assume the UE is receiving an eMBMS service from the MBSFN area 1, but not from the MBSFN area 2 and the MBSFN area 3. In order to continue receiving the eMBMS service properly, the UE may be receiving each of the MBSFN area configuration messages for the MBSFN area 1. The UE may keep a list of TMGIs current with respect to the MBSFN area 1. As such, in step 1002, the UE may acquire only the MBSFN area configuration messages for the MBSFN area 2 and the MBSFN area 3, and construct the list of TMGIs based on the current list of TMGIs for the MBSFN area 1 and the MBSFN area configuration messages for the MBSFN area 2 and the MBSFN area 3.

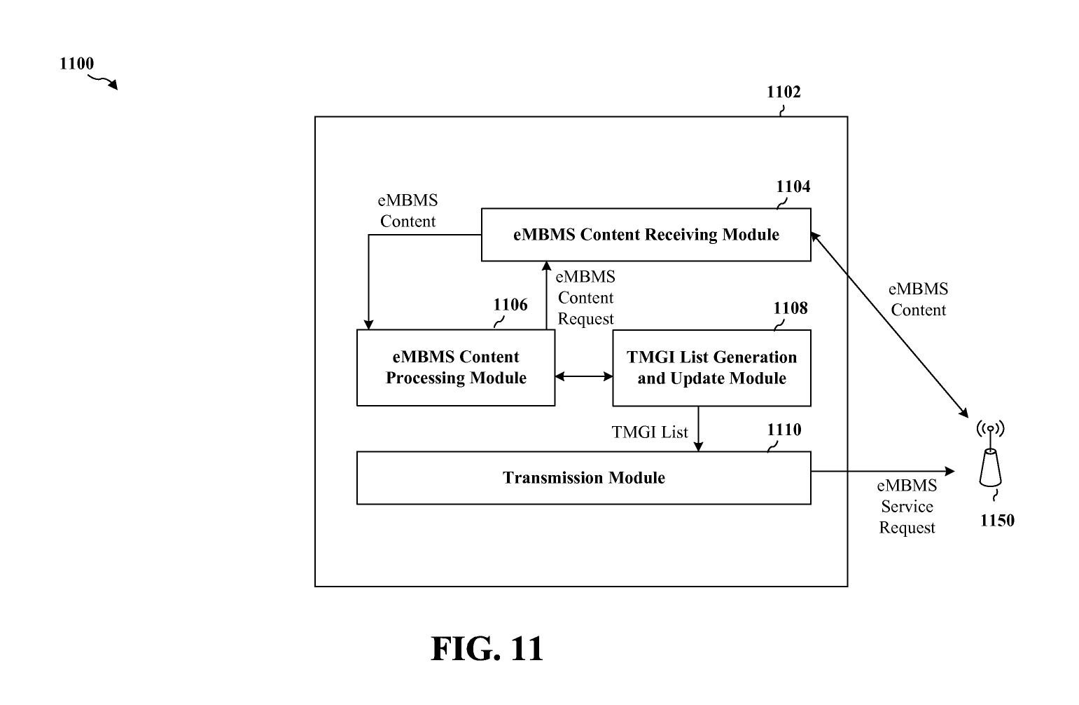

FIG. 11 is a conceptual data flow diagram 1100 illustrating the data flow between different modules/means/components in an exemplary apparatus 1102. The apparatus may be a UE. The apparatus includes an eMBMS content receiving module 1104, an eMBMS content processing module 1106, and a TMGI list generation and update module 1108. The apparatus may further include a transmission module 1110. The transmission module 1110 is configured to receive the TMGI list and request an eMBMS service from the eNB 1150 based on the TMGI list. The eMBMS content receiving module 1104 is configured to receive at least one MBMS service in at least one MBSFN area. The eMBMS content receiving module 1104 is also configured to receive configuration information on at least one MCCH. The at least one MCCH includes an MCCH unassociated with the at least one MBSFN area currently being received by the apparatus and associated with other MBSFN areas that are not currently being received by the apparatus. The TMGI list generation and update module 1108 is configured to construct a list of TMGIs based on the configuration information. The TMGI list generation and update module 1108 is configured to update the list of TMGIs based on at least one of an MCCH change notification message for each of the at least one MCCH or a USD.

To update the list of TMGIs, the eMBMS content receiving module 1104 may be configured to receive an MCCH change notification for the at least one MCCH. The eMBMS content processing module 1106 may be configured to determine that the MCCH change notification indicates a change for one or more MCCHs of the at least one MCCH. The eMBMS content receiving module 1104 may be configured to acquire the configuration information for the one or more MCCHs. The TMGI list generation and update module 1108 may be configured to add at least one TMGI to the list of TMGIs based on the configuration information. The TMGI list generation and update module 1108 may be configured to update the list of TMGIs by deleting at least one TMGI from the list based on the configuration information.

To update the list of TMGIs, the eMBMS content receiving module 1104 may be configured to receive the USD. The eMBMS content processing module 1106 may be configured to determine that a service has ended for a TMGI based on the USD. The TMGI list generation and update module 1108 may be configured to delete the TMGI from the list of TMGIs. The TMGI may be unassociated with the at least one MBSFN area.

To update the list of TMGIs, the eMBMS content receiving module 1104 may be configured to re-receive the configuration information, and the TMGI list generation and update module 1108 may be configured to reconstruct the list of TMGIs for each of the at least one MCCH based on the configuration information upon a cell change due to a handover, cell reselection, or a recovery from out of coverage. To update the list of TMGIs, the eMBMS content receiving module 1104 may be configured to re-receive the configuration information, and the TMGI list generation and update module 1108 may be configured to reconstruct the list of TMGIs for one or more MCCHs of the at least one MCCH based on the configuration information periodically once every n MCCH modification periods, where n is greater than or equal to 350. The one or more MCCHs may be unassociated with the at least one MBSFN area.

To update the list of TMGIs, the eMBMS content receiving module 1104 may be configured to receive the USD. The eMBMS content processing module 1106 may be configured to determine that a service has started for a TMGI based on the USD. The eMBMS content processing module 1106 may be configured to determine that the TMGI is not in the list of TMGIs. Upon a request by the eMBMS content processing module 1106, the eMBMS content receiving module 1104 may be configured to re-receive the configuration information, and the TMGI list generation and update module 1108 may be configured to reconstruct the list of TMGIs based on the configuration information for one or more MCCHs of the at least one MCCH. The one or more MCCHs may be unassociated with the at least one MBSFN area. The at least one MCCH may include an MCCH for each MBSFN area indicated in a received SIB.

The apparatus may include additional modules that perform each of the steps of the algorithm in the aforementioned flow chart of FIG. 10. As such, each step in the aforementioned flow chart of FIG. 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

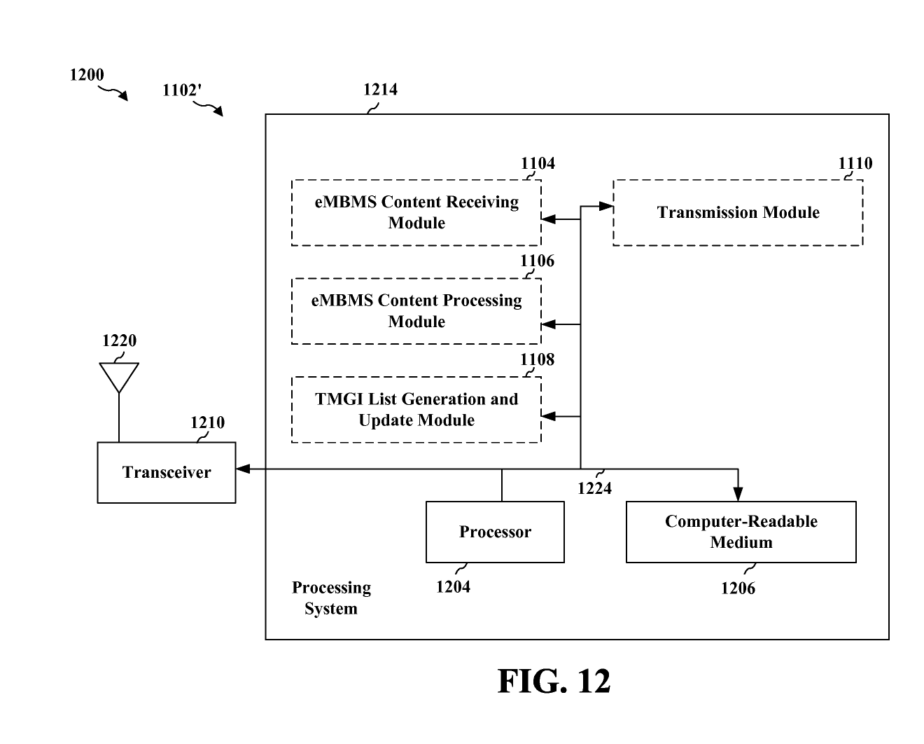

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1104, 1106, 1108, 1110 and the computer-readable medium 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214. In addition, the transceiver 1210 receives information from the processing system 1214, and based on the received information, generates a signal to be applied to the one or more antennas 1220. The processing system 1214 includes a processor 1204 coupled to a computer-readable medium 1206. The processor 1204 is responsible for general processing, including the execution of software stored on the computer-readable medium 1206. The software, when executed by the processor 1204, causes the processing system 1214 to perform the various functions described supra for any particular apparatus. The computer-readable medium 1206 may also be used for storing data that is manipulated by the processor 1204 when executing software. The processing system further includes at least one of the modules 1104, 1106, 1108, 1110. The modules may be software modules running in the processor 1204, resident/stored in the computer readable medium 1206, one or more hardware modules coupled to the processor 1204, or some combination thereof. The processing system 1214 may be a component of the UE 650 and may include the memory 660 and/or at least one of the TX processor 668, the RX processor 656, and the controller/processor 659.

In one configuration, the apparatus 1102/1102′ for wireless communication includes means for receiving at least one MBMS service in at least one MBSFN area. The apparatus further includes means for receiving configuration information on at least one MCCH. The at least one MCCH includes an MCCH unassociated with the at least one MBSFN area. The apparatus further includes means for constructing a list of TMGIs based on the configuration information. The apparatus further includes means for updating the list of TMGIs based on at least one of an MCCH change notification message for each of the at least one MCCH or a USD. The means for updating the list of TMGIs may be configured to receive an MCCH change notification for the at least one MCCH, to determine that the MCCH change notification indicates a change for one or more MCCHs of the at least one MCCH, to acquire the configuration information for the one or more MCCHs, and to add at least one TMGI to the list of TMGIs based on the configuration information. The means for updating the list of TMGIs may be configured to delete at least one TMGI from the list based on the configuration information. The means for updating the list of TMGIs may be configured to receive the USD, to determine that a service has ended for a TMGI based on the USD, and to delete the TMGI from the list of TMGIs. The TMGI may be unassociated with the at least one MBSFN area. The means for updating the list of TMGIs may be configured to re-receive the configuration information and to reconstruct the list of TMGIs for each of the at least one MCCH based on the configuration information upon a cell change due to a handover, cell reselection, or a recovery from out of coverage. The means for updating the list of TMGIs may be configured to re-receive the configuration information and to reconstruct the list of TMGIs for one or more MCCHs of the at least one MCCH based on the configuration information periodically once every n MCCH modification periods, where n is greater than or equal to 350. The one or more MCCHs may be unassociated with the at least one MBSFN area. The means for updating the list of TMGIs may be configured to receive the USD, to determine that a service has started for a TMGI based on the USD, to determine that the TMGI is not in the list of TMGIs, and to re-receive the configuration information and reconstructing the list of TMGIs based on the configuration information for one or more MCCHs of the at least one MCCH. The one or more MCCHs may be unassociated with the at least one MBSFN area.

The aforementioned means may be one or more of the aforementioned modules of the apparatus 1102 and/or the processing system 1214 of the apparatus 1102′ configured to perform the functions recited by the aforementioned means. As described supra, the processing system 1214 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving at least one multimedia broadcast multicast service (MBMS) service in at least one Multicast Broadcast Single Frequency Network (MBSFN) area;
receiving configuration information on at least one multicast control channel (MCCH), the at least one MCCH including an MCCH unassociated with the at least one MBSFN area;
constructing a list of temporary mobile group identities (TMGIs) based on the configuration information; and
updating the list of TMGIs based on at least one of an MCCH change notification message for each of the at least one MCCH or a user service description.

2. The method of claim 1, wherein the updating the list of TMGIs comprises:
receiving an MCCH change notification for the at least one MCCH;
determining that the MCCH change notification indicates a change for one or more MCCHs of the at least one MCCH;
acquiring the configuration information for the one or more MCCHs; and
adding at least one TMGI to the list of TMGIs based on the configuration information.

3. The method of claim 2, wherein the updating the list of TMGIs further comprises deleting at least one TMGI from the list based on the configuration information.

4. The method of claim 1, wherein the updating the list of TMGIs comprises:
receiving the user service description;
determining that a service has ended for a TMGI based on the user service description; and
deleting the TMGI from the list of TMGIs.

5. The method of claim 4, wherein the one or more TMGIs are unassociated with the at least one MBSFN area.

6. The method of claim 1, wherein the updating the list of TMGIs comprises re-receiving the configuration information and reconstructing the list of TMGIs for each of the at least one MCCH based on the configuration information upon a cell change due to a handover, cell reselection, or a recovery from out of coverage.

7. The method of claim 1, wherein the updating the list of TMGIs comprises re-receiving the configuration information and reconstructing the list of TMGIs for one or more MCCHs of the at least one MCCH based on the configuration information periodically once every n MCCH modification periods, where n is greater than or equal to 350.

8. The method of claim 7, wherein the one or more MCCHs are unassociated with the at least one MBSFN area.

9. The method of claim 1, wherein the updating the list of TMGIs comprises:
receiving the user service description;
determining that a service has started for a TMGI based on the user service description;
determining that the TMGI is not in the list of TMGIs; and
re-receiving the configuration information and reconstructing the list of TMGIs based on the configuration information for one or more MCCHs of the at least one MCCH.

10. The method of claim 9, wherein the one or more MCCHs are unassociated with the at least one MBSFN area.

11. The method of claim 1, wherein the at least one MCCH includes an MCCH for each Multicast Broadcast Single Frequency Network (MBSFN) area indicated in a received system information block (SIB).

12. An apparatus for wireless communication, comprising:
means for receiving at least one multimedia broadcast multicast service (MBMS) service in at least one Multicast Broadcast Single Frequency Network (MBSFN) area;
means for receiving configuration information on at least one multicast control channel (MCCH), the at least one MCCH including an MCCH unassociated with the at least one MBSFN area;
means for constructing a list of temporary mobile group identities (TMGIs) based on the configuration information; and
means for updating the list of TMGIs based on at least one of an MCCH change notification message for each of the at least one MCCH or a user service description.

13. The apparatus of claim 12, wherein the means for updating the list of TMGIs is configured to:
receive an MCCH change notification for the at least one MCCH;
determine that the MCCH change notification indicates a change for one or more MCCHs of the at least one MCCH;
acquire the configuration information for the one or more MCCHs; and
add at least one TMGI to the list of TMGIs based on the configuration information.

14. The apparatus of claim 13, wherein the means for updating the list of TMGIs is configured to delete at least one TMGI from the list based on the configuration information.

15. The apparatus of claim 12, wherein the means for updating the list of TMGIs is configured to:
receive the user service description;
determine that a service has ended for a TMGI based on the user service description; and
delete the TMGI from the list of TMGIs.

16. The apparatus of claim 15, wherein the one or more TMGIs are unassociated with the at least one MBSFN area.

17. The apparatus of claim 12, wherein the means for updating the list of TMGIs is configured to re-receive the configuration information and to reconstruct the list of TMGIs for each of the at least one MCCH based on the configuration information upon a cell change due to a handover, cell reselection, or a recovery from out of coverage.

18. The apparatus of claim 12, wherein the means for updating the list of TMGIs is configured to re-receive the configuration information and to reconstruct the list of TMGIs for one or more MCCHs of the at least one MCCH based on the configuration information periodically once every n MCCH modification periods, where n is greater than or equal to 350.

19. The apparatus of claim 18, wherein the one or more MCCHs are unassociated with the at least one MBSFN area.

20. The apparatus of claim 12, wherein the means for updating the list of TMGIs is configured to:
receive the user service description;
determine that a service has started for a TMGI based on the user service description;
determine that the TMGI is not in the list of TMGIs; and
re-receive the configuration information and reconstructing the list of TMGIs based on the configuration information for one or more MCCHs of the at least one MCCH.

21. The apparatus of claim 20, wherein the one or more MCCHs are unassociated with the at least one MBSFN area.

22. The apparatus of claim 12, wherein the at least one MCCH includes an MCCH for each Multicast Broadcast Single Frequency Network (MBSFN) area indicated in a received system information block (SIB).

23. An apparatus for wireless communication, comprising:
a processing system configured to:
receive at least one multimedia broadcast multicast service (MBMS) service in at least one Multicast Broadcast Single Frequency Network (MBSFN) area;
receive configuration information on at least one multicast control channel (MCCH), the at least one MCCH including an MCCH unassociated with the at least one MBSFN area;
construct a list of temporary mobile group identities (TMGIs) based on the configuration information; and
update the list of TMGIs based on at least one of an MCCH change notification message for each of the at least one MCCH or a user service description.

24. The apparatus of claim 23, wherein the processing system is configured to update the list of TMGIs by:
receiving an MCCH change notification for the at least one MCCH;
determining that the MCCH change notification indicates a change for one or more MCCHs of the at least one MCCH;
acquiring the configuration information for the one or more MCCHs; and
adding at least one TMGI to the list of TMGIs based on the configuration information.

25. The apparatus of claim 24, wherein the processing system is configured to update the list of TMGIs by deleting at least one TMGI from the list based on the configuration information.

26. The apparatus of claim 23, wherein the processing system is configured to update the list of TMGIs by:
receiving the user service description;
determining that a service has ended for a TMGI based on the user service description; and
deleting the TMGI from the list of TMGIs.

27. The apparatus of claim 26, wherein the one or more TMGIs are unassociated with the at least one MBSFN area.

28. The apparatus of claim 23, wherein the processing system is configured to update the list of TMGIs by re-receiving the configuration information and reconstructing the list of TMGIs for each of the at least one MCCH based on the configuration information upon a cell change due to a handover, cell reselection, or a recovery from out of coverage.

29. The apparatus of claim 23, wherein the processing system is configured to update the list of TMGIs by re-receiving the configuration information and reconstructing the list of TMGIs for one or more MCCHs of the at least one MCCH based on the configuration information periodically once every n MCCH modification periods, where n is greater than or equal to 350.

30. The apparatus of claim 29, wherein the one or more MCCHs are unassociated with the at least one MBSFN area.

31. The apparatus of claim 23, wherein the processing system is configured to update the list of TMGIs by:
receiving the user service description;
determining that a service has started for a TMGI based on the user service description;
determining that the TMGI is not in the list of TMGIs; and
re-receiving the configuration information and reconstructing the list of TMGIs based on the configuration information for one or more MCCHs of the at least one MCCH.

32. The apparatus of claim 31, wherein the one or more MCCHs are unassociated with the at least one MBSFN area.

33. The apparatus of claim 23, wherein the at least one MCCH includes an MCCH for each Multicast Broadcast Single Frequency Network (MBSFN) area indicated in a received system information block (SIB).

34. A computer program product, comprising:
a computer-readable medium comprising code for:
receiving at least one multimedia broadcast multicast service (MBMS) service in at least one Multicast Broadcast Single Frequency Network (MBSFN) area;
receiving configuration information on at least one multicast control channel (MCCH), the at least one MCCH including an MCCH unassociated with the at least one MBSFN area;
constructing a list of temporary mobile group identities (TMGIs) based on the configuration information; and
updating the list of TMGIs based on at least one of an MCCH change notification message for each of the at least one MCCH or a user service description.

35. The computer program product of claim 34, wherein the code for updating the list of TMGIs comprises code for:
receiving an MCCH change notification for the at least one MCCH;
determining that the MCCH change notification indicates a change for one or more MCCHs of the at least one MCCH;
acquiring the configuration information for the one or more MCCHs; and
adding at least one TMGI to the list of TMGIs based on the configuration information.

36. The computer program product of claim 35, wherein the code for updating the list of TMGIs further comprises code for deleting at least one TMGI from the list based on the configuration information.

37. The computer program product of claim 34, wherein the code for updating the list of TMGIs comprises code for:
receiving the user service description;
determining that a service has ended for a TMGI based on the user service description; and
deleting the TMGI from the list of TMGIs.

38. The computer program product of claim 37, wherein the one or more TMGIs are unassociated with the at least one MBSFN area.

39. The computer program product of claim 34, wherein the code for updating the list of TMGIs comprises code for re-receiving the configuration information and reconstructing the list of TMGIs for each of the at least one MCCH based on the configuration information upon a cell change due to a handover, cell reselection, or a recovery from out of coverage.

40. The computer program product of claim 34, wherein the code for updating the list of TMGIs comprises code for re-receiving the configuration information and reconstructing the list of TMGIs for one or more MCCHs of the at least one MCCH based on the configuration information periodically once every n MCCH modification periods, where n is greater than or equal to 350.

41. The computer program product of claim 40, wherein the one or more MCCHs are unassociated with the at least one MBSFN area.

42. The computer program product of claim 34, wherein the code for updating the list of TMGIs comprises code for:
receiving the user service description;
determining that a service has started for a TMGI based on the user service description;
determining that the TMGI is not in the list of TMGIs; and
re-receiving the configuration information and reconstructing the list of TMGIs based on the configuration information for one or more MCCHs of the at least one MCCH.

43. The computer program product of claim 42, wherein the one or more MCCHs are unassociated with the at least one MBSFN area.

44. The computer program product of claim 34, wherein the at least one MCCH includes an MCCH for each Multicast Broadcast Single Frequency Network (MBSFN) area indicated in a received system information block (SIB).
